(19) United States
(12) Patent Application Publication
(10) Pub. No.: US 2026/0210392 A1
(43) Pub. Date: Jul. 23, 2026

(54) Fastening Device for a Fastening System for Fastening a Component

(71) Applicant: Illinois Tool Works Inc., Glenview, IL (US)

(72) Inventors: Jacqueline Gädecke, Parsau (DE); Javier Arteta, Puente de la Reina (ES)

(21) Appl. No.: 19/439,105

(22) Filed: Jan. 2, 2026

(30) Foreign Application Priority Data
Jan. 17, 2025 (DE) 102025101599.6

(51) Int. Cl. F16B 21/07; F16B 21/09

(52) U.S. Cl. CPC F16B 21/073; F16B 21/09

(57) ABSTRACT

The disclosure relates to a fastening device (1) for a fastening system for fastening a component to a component carrier (2), wherein a stud (3) projects from a surface of the component carrier (2). The fastening device (1) comprises a spring clip (4), which comprises a base body (5) having a stud receptacle (6), in which the stud (3) and, in particular, a stud head (7) of the stud (3) are receivable at least partially or regionally and are then fixable by self-locking. The stud receptacle (6) is configured such that it elastically spreads open for at least partial or regional reception of the stud (3) and, in particular, of the stud head (7) when the stud (3) is inserted into the stud receptacle (6), wherein the base body (5) of the spring clip (4) comprises at least one locking element (8) which is configured to block an, in particular, elastic spreading-open of the stud receptacle (6) when a force acting counter to the insertion direction (F) of the stud (3) is exerted on the stud (3) at least partially or regionally received in the stud receptacle (6).

### RELATED APPLICATIONS

The present application claims the benefit of German Patent Application No. 102025101599.6, filed Jan. 17, 2025, titled “Fastening Device for a Fastening System for Fastening a Component,” the contents of which are hereby incorporated by reference.

### BACKGROUND

Fastening systems of the type considered herein are used, in particular, in body construction. The fastening system serves, in particular, to fasten or mount add-on parts to a body, for example, a body of a passenger vehicle. The add-on parts may be trim parts, holders for electrical lines, fluid lines, and the like. The fastening should be as simple as possible. In many cases, the fastening should also be releasable again without causing destruction. Finally, the fastening systems should frequently be capable of compensating dimensional deviations (tolerance compensation).

For example, publication DE 10 2009 014 133 A1 discloses a fastening clip for fastening a component to a stud of a carrier part. The fastening clip comprises a base body having an opening for receiving the stud, wherein the opening has an axis and, transversely to the axis, adjacent to one another, a fastening region and a release region. In the fastening region, resilient retaining means for retaining the stud are arranged, which are configured such that the stud may be inserted into the fastening region in the direction of the axis and the stud located in the fastening region may be displaced into the release region by a relative movement of the stud and the fastening clip transversely to the axis of the opening. In the release region, the stud is removable from the opening.

From publication EP 3 409 057 A1, a further fastening clip is known which is mountable on a stud. An opening comprises a first and a second section, which are assigned to a mounting position and a demounting position, respectively.

The studs used in such fastening systems may be threaded studs, so-called mushroom-head studs, or similar elements. The studs are generally welded onto a body panel by means of a so-called stud welding process or are adhesively bonded.

An objective of the present disclosure is to specify a fastening device for such a fastening system, wherein the fastening device should, in particular, be distinguished in that a connection between the stud and the fastening device is achievable with the lowest possible mounting force, while, in the mounted state, the fastening device exhibits a very high retaining force or pull-off force.

### SUMMARY

The present disclosure relates generally to a fastening device, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in an isometric view the spring clip of the exemplary embodiment of the fastening device according to the disclosure.

FIG. 2 illustrates schematically and in a top view the spring clip according to FIG. 1.

FIG. 3 illustrates schematically and in a side view the spring clip according to FIG. 1.

FIG. 4 illustrates schematically and in an end-face side view the spring clip according to FIG. 1.

FIG. 5 illustrates schematically and in an isometric view the spring clip according to FIG. 1 together with the receptacle of the fastening device connectable to the component to be fastened, in a state in which the spring clip is being inserted into the receptacle.

FIG. 6 illustrates schematically and in an isometric view the receptacle according to FIG. 5 together with the spring clip according to FIG. 1, in a state in which the spring clip is received in the receptacle.

FIG. 7 illustrates schematically and in an isometric view the arrangement according to FIG. 6.

FIG. 8 illustrates schematically and in a partially transparent top view the arrangement according to FIG. 7.

FIG. 9 illustrates schematically and in a side view the arrangement according to FIG. 6 together with a component carrier having a stud, in a state in which the stud of the component carrier is inserted into the stud receptacle of the base body of the spring clip.

FIG. 10 illustrates schematically and in a side view the arrangement according to FIG. 9, in a state after the stud of the component carrier is received in the stud receptacle of the base body of the spring clip.

FIG. 11 illustrates schematically and in a side view the arrangement according to FIG. 10.

FIG. 12 illustrates schematically and in a side view the arrangement according to FIG. 11, in a state in which a connection between the component carrier and the stud with the spring clip is released.

FIG. 13 illustrates schematically and in a side view the arrangement according to FIG. 12, in a state after the component carrier with the stud has been released from the spring clip.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure generally relates to an optimized fastening solution for fastening a vehicle component, in particular, an interior component of a vehicle, to a body component.

In particular, the disclosure relates to a fastening device for a fastening system for fastening a component, in particular, an add-on part or trim part, to a component carrier, in particular, to a body part of a vehicle. The fastening device may, in particular, be implemented as a spring clip or fastening clip. As an alternative thereto, the fastening device comprises a spring clip.

According to a further aspect, the disclosure relates to a corresponding fastening system having at least one such fastening device.

An objective of the present disclosure is to specify a fastening device for such a fastening system, wherein the fastening device should, in particular, be distinguished in that a connection between the stud and the fastening device is achievable with the lowest possible mounting force, while, in the mounted state, the fastening device exhibits a very high retaining force or pull-off force.

This objective is achieved according to the disclosure, in particular, by the subject matter of independent patent claim 1. This relates to a fastening device for a fastening system for fastening a component to a component carrier. The component is, in particular, an add-on part or trim part, in particular, a vehicle interior part. The component carrier is preferably a body part of a vehicle. It is provided that a stud projects from a surface of the component carrier.

The fastening device according to the disclosure comprises a spring clip, which, in a figurative sense, constitutes a fastening clip. The spring clip comprises a base body having a stud receptacle, in which the stud of the component carrier and, in particular, a stud head of the stud of the component carrier are receivable at least partially or regionally and are then, that is to say, in the received state of the stud or the stud head, fixable, in particular, by self-locking.

In order to achieve that the fastening device and, in particular, the spring clip serving as a fastening clip of the fastening device has the lowest possible mounting force for inserting the stud or the stud head into the stud receptacle but then exhibits the highest possible retaining force, it is provided according to the disclosure, in particular, that the stud receptacle is configured such that it elastically spreads open for at least partial or regional reception of the stud and, in particular, of the stud head when the stud is inserted into the stud receptacle. The base body of the spring clip comprises at least one locking element, which is configured to block or prevent an, in particular, elastic spreading-open of the stud receptacle when a force acting counter to the insertion direction of the stud is exerted on the stud at least partially or regionally received in the stud receptacle.

According to preferred implementations of the fastening device according to the disclosure, it is provided that a counter element configured to be at least partially or regionally complementary to the at least one locking element of the spring clip is assigned to the locking element. The locking element and the corresponding counter element are in engagement by spring force, whereby an, in particular, elastic spreading-open of the stud receptacle is blocked.

By contrast, this blocking is releasable when the engagement between the locking element and the corresponding counter element is released. This is preferably achieved in that a force component overcoming the spring force is exerted on the stud receptacle in the insertion direction of the stud.

According to preferred embodiment variants of the fastening device according to the disclosure, it is provided that the fastening device further comprises a receptacle connected or connectable to the component to be fastened. This receptacle serves to receive the spring clip and, in particular, the stud receptacle of the spring clip at least partially or regionally.

According to further developments, in particular, of the last-mentioned embodiment variant of the fastening device according to the disclosure, it is provided that the spring clip is configured such that at least the stud receptacle and/or the at least one locking element of the spring clip, in the state in which the spring clip and, in particular, the stud receptacle of the spring clip is at least partially or regionally received in the receptacle, is movable in the insertion direction relative to the receptacle upon the action of a force component in the insertion direction of the stud on the stud receptacle.

In particular in this context, it may be provided that the receptacle of the fastening device comprises, on one side of the receptacle, a receptacle opening, via which the spring clip and, in particular, the stud receptacle of the spring clip are introducible or insertable into the receptacle at least partially or regionally.

Furthermore, according to embodiment variants of the fastening device according to the disclosure, it is provided that the receptacle of the fastening device comprises, in a side wall adjacent to the side having the receptacle opening, a through opening which, when the stud receptacle of the spring clip is at least partially or regionally received in the receptacle, is at least substantially aligned with the stud receptacle of the spring clip.

In order to further simplify insertion of the stud into the stud receptacle, it is provided according to advantageous further developments of the fastening device according to the disclosure that an insertion aid, in particular, in the form of an insertion chamfer, is assigned to the stud receptacle.

According to preferred implementations of the fastening device according to the disclosure, it is provided that the receptacle opening of the receptacle of the fastening device and/or the spring clip of the fastening device are/is configured such that the spring clip is removable from the receptacle through the receptacle opening, even when the stud or the stud head of the component carrier is received and fixed at least partially or regionally by the stud receptacle.

In other words, mounting of the component, which is, in particular, configured as an add-on part or trim part, to the component carrier, which is, in particular, configured as a body part, is carried out in that the stud of the component carrier is inserted in the insertion direction into the stud receptacle of the spring clip. Demounting is not possible by exerting a corresponding force component counter to the insertion direction on the stud or the component carrier or the trim part, since, due to the provision of the at least one locking element, the fastening device exhibits an optimized retaining force. Once the stud or stud head is received and fixed by the stud receptacle of the spring clip, demounting is only possible by moving the stud together with the spring clip laterally, that is to say, perpendicular to the insertion direction of the stud, out of the receptacle opening of the receptacle of the fastening device.

For fixing the spring clip and, in particular, the stud receptacle of the spring clip in the receptacle of the fastening device, the spring clip preferably comprises a latching element, which is configured such that even in the latched state of the spring clip, the spring clip or at least the stud receptacle of the spring clip is still movable relative to the receptacle in the insertion direction.

Different embodiment variants may be considered for the at least one locking element of the spring clip. For example, it is conceivable that the counter element configured to be at least partially or regionally complementary to the at least one locking element is part of the receptacle. In particular, in this context, it is advantageous that the counter element is configured as a recess region formed in an, in particular, upper structure of the receptacle of the fastening device, and that the corresponding locking element of the spring clip is configured as a region projecting at least partially or regionally in the direction of the recess region of the receptacle of the fastening device.

Preferably, the spring clip comprises at least one spring arm for generating a corresponding spring force. This spring force serves to keep the at least one locking element of the spring clip in engagement with the corresponding counter element in order to block an, in particular, elastic spreading-open of the stud receptacle.

In this context, it is advantageous that the at least one spring arm of the spring clip is connected to and/or configured with the base body of the spring clip such that, in the state in which the stud receptacle is at least partially or regionally received in the receptacle, a region of the side wall of the receptacle in which the through opening is formed is at least partially or regionally received between the at least one spring arm of the spring clip and the base body of the spring clip.

The disclosure further relates to a fastening system for fastening an add-on part or a trim part to a carrier part, in particular, to a body part of a motor vehicle, wherein the fastening device comprises at least one fastening device of the previously described type according to the disclosure and a stud projecting from a surface of the component carrier.

Preferably, the stud comprises a stud shank and a stud head, the diameter of which is greater than that of the stud shank. The stud head may form a latching contour on its axial side facing the stud shank.

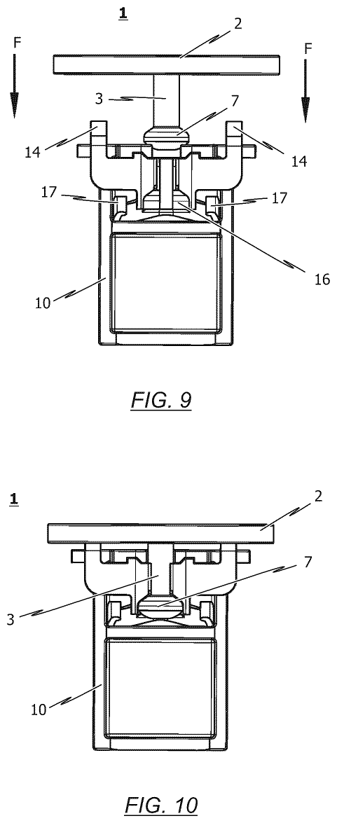

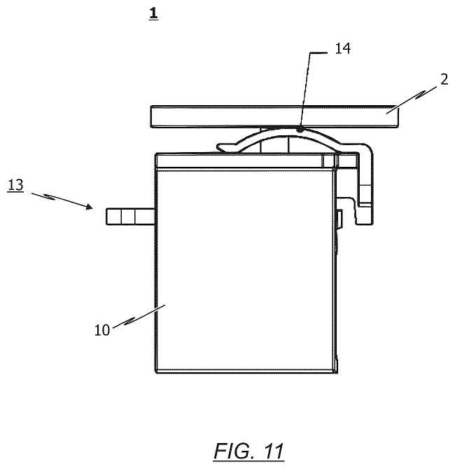

The exemplary embodiment of the fastening device 1 according to the disclosure is, in particular, configured as a door trim clip for fastening to a stud 3 of a component carrier 2. For mounting the fastening device 1 on the component carrier 2 or on the stud 3 of the component carrier 2, the clip, which essentially comprises a spring clip 4, is mounted against the stud 3, as shown schematically in FIG. 9 and FIG. 10.

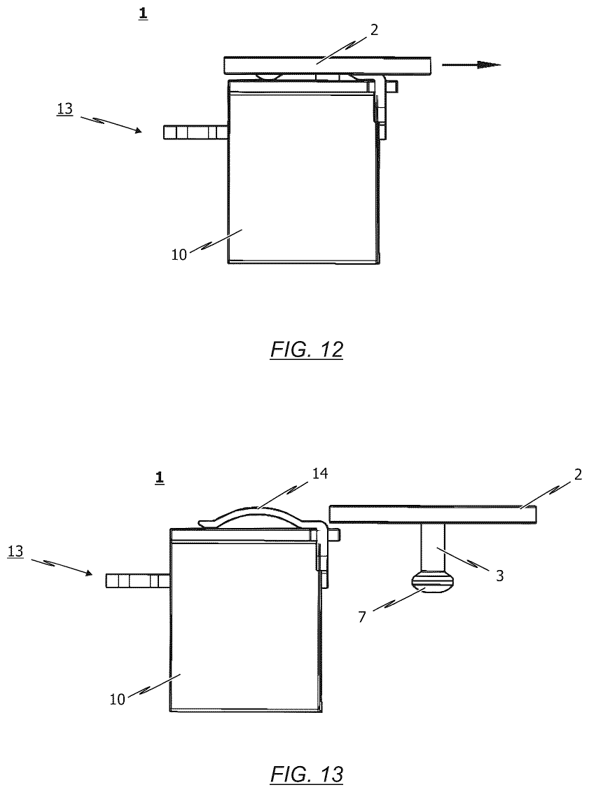

For demounting the door trim clip from the component carrier 2 or from the stud 3 of the component carrier 2, the fastening device 1 is to be pressed against the component carrier 2 and then pulled off laterally, as schematically indicated in FIG. 12 and FIG. 13.

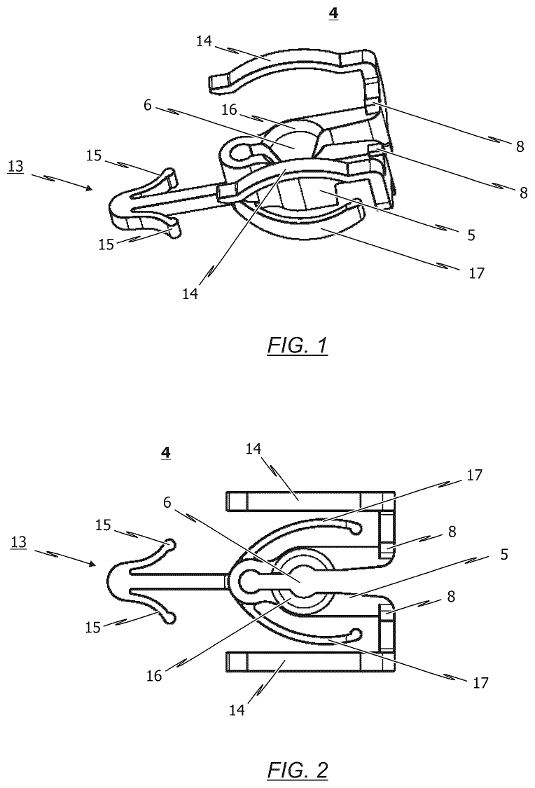

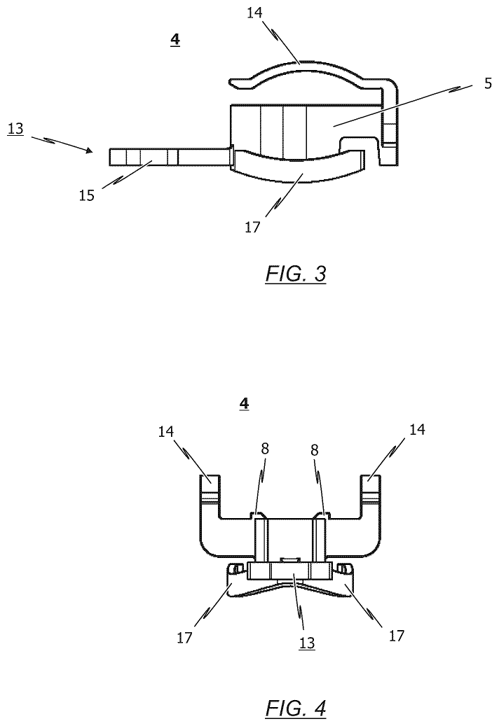

The spring clip 4 forming the clip of the fastening device 1 is shown schematically in FIG. 1 to FIG. 4.

Briefly summarized, the spring clip 4 comprises a base body 5 having a stud receptacle 6, in which the stud 3 of the component carrier 2 and, in particular, a stud head of the stud 3 of the component carrier 2 are receivable at least partially or regionally. In the received state, the stud head 7 of the stud 3 of the component carrier 2 is fixed in the stud receptacle 6 by self-locking.

In particular, for this purpose, the stud receptacle 6 is configured such that it elastically spreads open for at least partial or regional reception of the stud head 7 when the stud 3 is inserted into the stud receptacle 6.

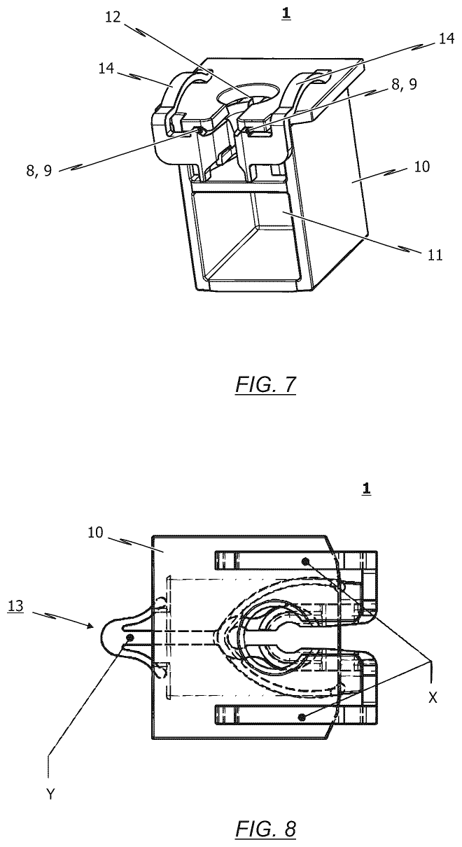

As may be derived, in particular, from the illustration in FIG. 7, the base body 5 of the spring clip 4 comprises locking elements 8, which are configured to block an elastic spreading-open of the stud receptacle 6 when a force acting counter to the insertion direction F of the stud 3 is exerted on the stud 3 of the component carrier 2 at least partially or regionally received in the stud receptacle 6 of the spring clip 4.

Returning to the illustration in FIG. 7, it should be noted that, in the exemplary embodiment of the fastening device 1 according to the disclosure shown in the drawings, counter elements 9 configured to be at least partially or regionally complementary thereto are assigned to the locking elements 8 of the spring clip 4.

The corresponding counter elements 9, which are configured to be complementary to the locking elements 8 of the spring clip 4, are part of the receptacle 10 of the fastening device 1, in which the spring clip 4 is received at least regionally.

The spring clip 4 further comprises lateral spring arms 17, which laterally support the base body 5 of the spring clip 4 against an inner wall region of the receptacle 10 when the spring clip 4 is received in the receptacle 10.

In particular, in the embodiment of the fastening device 1 according to the disclosure shown in the drawings, the counter elements 9 are each configured as a recess region formed in an upper structure of the receptacle 10, wherein the corresponding locking element 8 of the spring clip 4 is configured as a region projecting at least partially or regionally in the direction of the recess region.

The locking elements 8 of the spring clip 4 and the corresponding counter elements 9 of the receptacle 10 are configured and interact with one another such that they are in engagement by spring force. The spring force is generated by the corresponding spring arms 14 of the spring clip 4. As a result, an elastic spreading-open of the spring clip 4 and, in particular, of the stud receptacle 6 of the spring clip 4 is blocked.

The blocking and the engagement between the locking elements 8 of the spring clip 4 and the corresponding counter elements of the receptacle 10 are released when a force component overcoming the spring force is exerted on the stud receptacle 6 in the insertion direction F of the stud 3 (see FIG. 12).

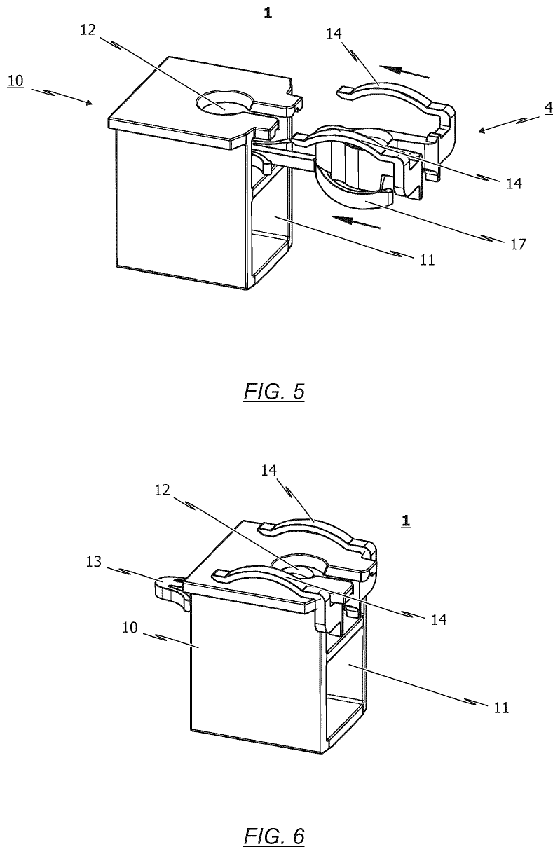

As may be derived, in particular, from FIG. 5 and FIG. 6, the spring clip 4 of the fastening device 1 and, in particular, the stud receptacle 6 of the spring clip 4 are receivable at least partially or regionally in the receptacle 10 of a housing structure of the component to be fastened (for example, the door trim). For this purpose, as shown in FIG. 5, the spring clip 4 is inserted into the receptacle 10 of the housing structure.

In the inserted state of the spring clip 4, the locking elements 8 of the spring clip 4 and the corresponding counter elements 9 of the receptacle 10 come into effect. In particular, the locking elements 8 of the spring clip 4 are pressed into the corresponding counter elements 9 of the receptacle 10 by the spring force of the spring arms 14 of the spring clip 4.

This blocking, which prevents an elastic spreading-open of the stud receptacle 6 of the spring clip 4, may be overcome when, upon the action of a force component in the insertion direction F on the stud receptacle 6, the stud receptacle 6 of the spring clip 4 is moved in the insertion direction F relative to the receptacle 10 counter to the spring force of the spring arms 14 (see FIG. 12).

As may be derived, in particular, from the isometric illustration according to FIG. 5, the receptacle 10 configured as a housing structure comprises, on one side, a receptacle opening 11, via which the spring clip 4 and, in particular, the stud receptacle 6 of the spring clip 4 are introducible into the receptacle 10 at least partially or regionally.

It may further be seen that the receptacle 10 comprises, in a side wall adjacent to the side having the receptacle opening 11, a through opening 12, which, in the state in which the stud receptacle 6 of the spring clip 4 is at least partially or regionally received in the receptacle 10, is at least substantially aligned with the stud receptacle 6 of the spring clip 4. This may be derived, in particular, from the top view according to FIG. 8.

The arrangement of the housing structure serving as the receptacle 10 and the spring clip 4 makes it possible for the spring clip 4 to be removable from the receptacle 10 or housing structure through the receptacle opening 11, even when the stud 3 and, in particular, the stud head 7 of the component carrier 2 is at least partially or regionally received by the stud receptacle 6.

For releasably fixing at least the stud receptacle 6 of the spring clip 4 in the receptacle 10 of the housing structure, the spring clip 4 comprises a latching element 13. In a state in which the spring clip 4 is inserted in the receptacle 10, the latching element 13 latches the spring clip 4 to the receptacle 10. The latching element 13 itself comprises spring arms 15 in order to ensure tolerance compensation Y in the Y direction, that is to say, in the insertion direction F of the spring clip 4 into the receptacle 10.

On the other hand, the base body 5 of the spring clip 4 is configured such that, when the spring clip 4 is inserted in the receptacle 10, it ensures tolerance compensation X in the X direction, as likewise indicated in FIG. 8.

The two spring arms 14 of the spring clip 4 are configured such that they push the component carrier 2 away from the receptacle 10 or housing structure of the fastening device 1 in the Z direction when the component carrier 2 or the stud 3 or stud head 7 of the component carrier 2 is received by the stud receptacle 6 of the spring clip 4 received in the receptacle 10.

In particular, the spring arms 14 of the spring clip 4 are connected to and formed with the base body 5 of the spring clip 4 such that, in the state in which the stud receptacle 6 of the spring clip 4 is received in the receptacle 10, a region of the side wall of the receptacle 10, in which the through opening 12 for the stud 3 or stud head 7 of the component carrier 2 is formed, is received at least partially or regionally between the spring arms 14 and the base body 5 of the spring clip 4.

From the partially transparent illustration in FIG. 8 or the illustration in FIG. 9, it may be derived that the stud receptacle 6 of the spring clip 4 comprises an insertion aid 16 in the form of an insertion chamfer in order to facilitate insertion of the stud head 7 into the stud receptacle 6.

The disclosure is not limited to the exemplary embodiment of the fastening device 1 shown in the drawings. Rather, the disclosure likewise relates to a fastening system for fastening a component, such as an interior trim part of a vehicle, to a carrier part which is configured, in particular, as a body part of a vehicle. The fastening system comprises a fastening device 1, as shown, for example, in the accompanying drawings, and a stud 3 projecting from a surface of the component carrier 2. The stud 3 itself comprises a stud shank and a stud head 7, wherein the diameter of the stud head 7 is greater than that of the stud shank. The stud head 7 forms a latching contour on its axial side facing the stud shank.

Thus, while the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1. fastening device
2 component carrier
3 stud
4 spring clip
5 base body of the spring clip
6 stud receptacle of the base body
7 stud head
8 locking element
9 counter element
10 receptacle
11 receptacle opening
12 through opening
13 latching element
14 spring arm
15 spring arm of the latching element
16 insertion aid
17 spring arm
F insertion direction
X tolerance compensation in the X direction
Y tolerance compensation in the Y direction

What is claimed is:

1. A fastening device (1) for a fastening system for fastening a component, in particular a component in the form of an add-on part or trim part, to a component carrier (2) and to a body part of a vehicle, wherein a stud (3) projects from a surface of the component carrier (2), and wherein the fastening device (1) comprises:
a spring clip (4), which comprises a base body (5) having a stud receptacle (6), in which the stud (3) and a stud head (7) of the stud (3) are receivable at least partially or regionally and are then fixable by self-locking,
wherein the stud receptacle (6) is configured such that it elastically spreads open for at least partial or regional reception of the stud (3) and of the stud head (7) when the stud (3) is inserted into the stud receptacle (6), wherein the base body (5) of the spring clip (4) comprises at least one locking element (8), which is configured to block an elastic spreading-open of the stud receptacle (6) when a force acting counter to the insertion direction (F) of the stud (3) is exerted on the stud (3) at least partially or regionally received in the stud receptacle (6).

2. A fastening device (1) according to claim 1,
wherein a counter element (9) configured to be at least partially or regionally complementary thereto is assigned to the at least one locking element (8) of the spring clip (4), wherein the locking element (8) and the corresponding counter element (9) are in engagement by spring force and thereby block an elastic spreading-open of the stud receptacle (6), wherein the blocking and the engagement between the locking element (8) and the corresponding counter element (9) are released when a force component overcoming the spring force is exerted on the stud receptacle (6) in the insertion direction (F) of the stud (3).

3. A fastening device (1) according to claim 1,
wherein the fastening device (1) further comprises:
a receptacle (10) connected or connectable to the component to be fastened,
wherein the spring clip (4) and the stud receptacle (6) of the spring clip (4) is received or receivable at least partially or regionally in the receptacle (10).

4. A fastening device (1) according to claim 3,
wherein the spring clip (4) is configured such that at least the stud receptacle (6) and/or the at least one locking element (8) of the spring clip (4), in the state in which the spring clip (4) and the stud receptacle (6) of the spring clip (4) is received at least partially or regionally in the receptacle (10), is movable in the insertion direction (F) relative to the receptacle (10) upon the action of a force component in the insertion direction (F) on the stud receptacle (6).

5. A fastening device (1) according to claim 3,
wherein the receptacle (10) comprises, on one side of the receptacle (10), a receptacle opening (11), via which the spring clip (4) and the stud receptacle (6) of the spring clip (4) are introducible into the receptacle (10) at least partially or regionally.

6. A fastening device (1) according to claim 5,
wherein the receptacle (10) comprises, in a side wall adjacent to the side having the receptacle opening (11), a through opening (12), which, in the state in which the stud receptacle (6) of the spring clip (4) is received at least partially or regionally in the receptacle (10), is at least substantially aligned with the stud receptacle (6) of the spring clip (4).

7. A fastening device (1) according to claim 6,
wherein the receptacle opening (11) and/or the spring clip (4) are/is configured such that the spring clip (4) is removable from the receptacle (10) through the receptacle opening (11), even when the stud (3) and the stud head (7) is received at least partially or regionally by the stud receptacle (6).

8. A fastening device (1) according to claim 3,
wherein the spring clip (4) comprises a latching element (13) for releasably fixing at least the stud receptacle (6) in the receptacle (10).

9. A fastening device (1) according to claim 3, wherein the counter element (9) configured to be at least partially or regionally complementary to the at least one locking element (8) is part of the receptacle (10).

10. A fastening device (1) according to claim 9,
wherein the counter element (9) is configured as a recess region formed in an upper structure of the receptacle (10), and the corresponding locking element (8) is configured as a region projecting at least partially or regionally in the direction of the recess region.

11. A fastening device (1) according to claim 2, wherein the spring clip (4) comprises at least one spring arm (14) for generating the spring force.

12. A fastening device (1) according to claim 6, wherein the at least one spring arm (14) is connected to and/or formed with the base body (5) of the spring clip (4) such that, in the state in which the stud receptacle (6) is received at least partially or regionally in the receptacle (10), a region of the side wall of the receptacle (10), in which the through opening (12) is formed, is received at least partially or regionally between the at least one spring arm (14) and the base body (5) of the spring clip (4).

13. A fastening device (1) according to claim 1,
wherein the stud receptacle (6) comprises an insertion aid (16) in the form of an insertion chamfer.

14. A fastening system for fastening a component in the form of an add-on part or trim part, to a carrier part which is configured as a body part of a vehicle, wherein the fastening system comprises:
a fastening device (1) according to claim 1; and
a stud (3) projecting from a surface of the component carrier (2).

15. A fastening system according to claim 14,
wherein the stud (3) comprises a stud shank and a stud head (7), the diameter of which is greater than that of the stud shank, wherein the stud head (7) forms a latching contour on its axial side facing the stud shank.
